(19) United States
(12) Patent Application Publication
(10) Pub. No.: US 2015/0277694 A1
(43) Pub. Date: Oct. 1, 2015

(54) MANAGEMENT SYSTEM FOR ICON AND METHOD FOR ELECTRONIC DEVICE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: YI-LAN MA, Shenzhen (CN); CHIH-HUA HSU, New Taipei (TW); SAI-RONG HUANG, Shenzhen (CN); CHIH-SAN CHIANG, New Taipei (TW)

(21) Appl. No.: 14/674,038

(22) Filed: Mar. 31, 2015

(30) Foreign Application Priority Data
Mar. 31, 2014 (CN) 201410124157.5

(51) Int. Cl. G06F 3/0486; G06F 3/0484

(52) U.S. Cl. CPC G06F 3/0486; G06F 3/04842; G06F 3/04847

(57) ABSTRACT

An icon management system and method for an electronic device are provided. The icon management system includes a number of software units stored in a storage device which are executed by a processor to: determine that a touch input applied to an icon is an icon move operation; actuate the icon into a moveable state; update the location of the icon in response to a drag operation on a current page; detect a trace corresponding to the drag operation on the current page; recognize the trace and determine whether the trace matches an image of a page number among a number of page numbers; control a display device to display a target page associated with a matched page number, if the trace matches an image of a page number among the page numbers; and locate the icon on the target page after the target page is displayed.

### CROSS-REFERENCE TO RELATED APPLICATIONS

This application claims priority to Chinese Patent Application No. 201410124157.5 filed on Mar. 31, 2014, the contents of which are incorporated by reference herein.

### FIELD

The subject matter herein generally relates to icon management.

### BACKGROUND

Electronic devices typically include many screen icons representing applications. A user has to drag the icon across one page or several pages to move the icon displayed on a current page to another page, which is inconvenient.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of an electronic device applying an icon management system.

FIG. 2 shows a diagrammatic view of a current page displayed on the electronic device of FIG. 1.

FIG. 3 shows a diagrammatic view of a current page and a trace inputted by a user displayed on the electronic device of FIG. 2.

FIG. 4 shows a diagrammatic view of a target page displayed on the electronic device of FIG. 1.

FIG. 5 is a flowchart of an embodiment of an icon management method of an electronic device, such as the one of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The “module” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

The present disclosure is described in relation to an icon management system and method for an electronic device. The icon management system comprises a number of software units stored in a storage device which are executed by a processor to determine that a touch input applied to an icon is an icon move operation, to actuate the icon into a moveable state, and update the location of the icon in response to a drag operation on a current page. Further, to detect a trace corresponding to the drag operation on the current page, recognize the trace and determine whether the trace matches an image of a page number among a number of page numbers, and control a display device to display a target page associated with a matched page number, if the trace matches an image of a page number among the number of page numbers. Further, to locate the icon on the target page after the target page is displayed.

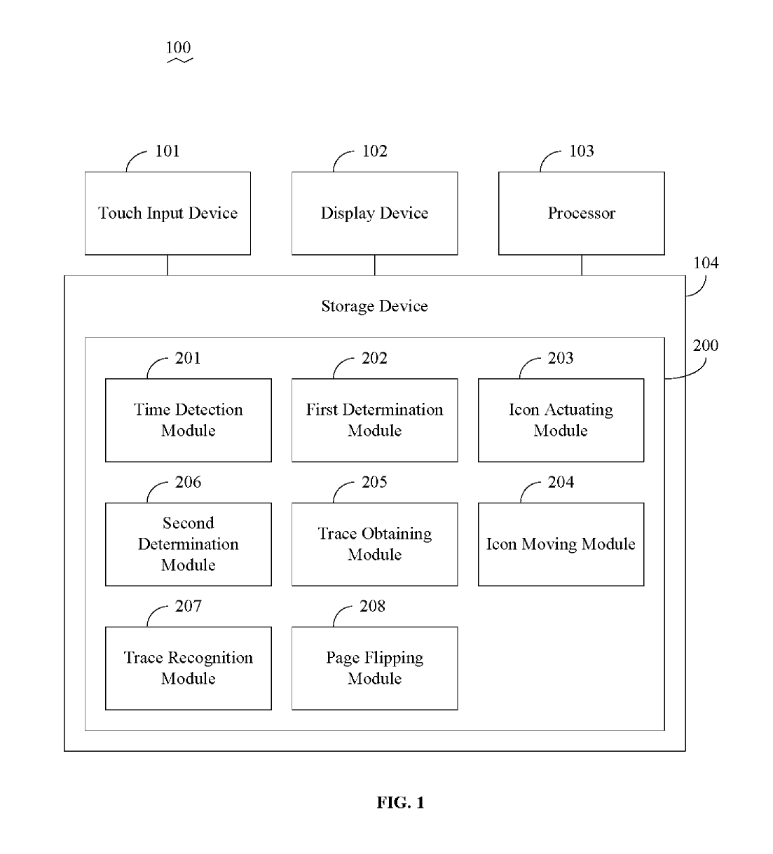

FIG. 1 illustrates an embodiment of an electronic device 100. An icon management system 200 is applied to the electronic device 100. The electronic device 100 can be a mobile phone or a tablet computer, or other portable device. The electronic device 100 can include a touch input device 101 and a display device 102. The electronic device 100 can also include at least one processor 103 and a storage device 104. In at least one embodiment, the electronic device 100 includes one processor 103. The processor 103 executes instructions of a number of modules stored in the storage device 104. The storage device 104 can store a time detection module 201, a first determination module 202, an icon actuating module 203, an icon moving module 204, a trace obtaining module 205, a second determination module 206, a trace recognition module 207, and a page flipping module 208.

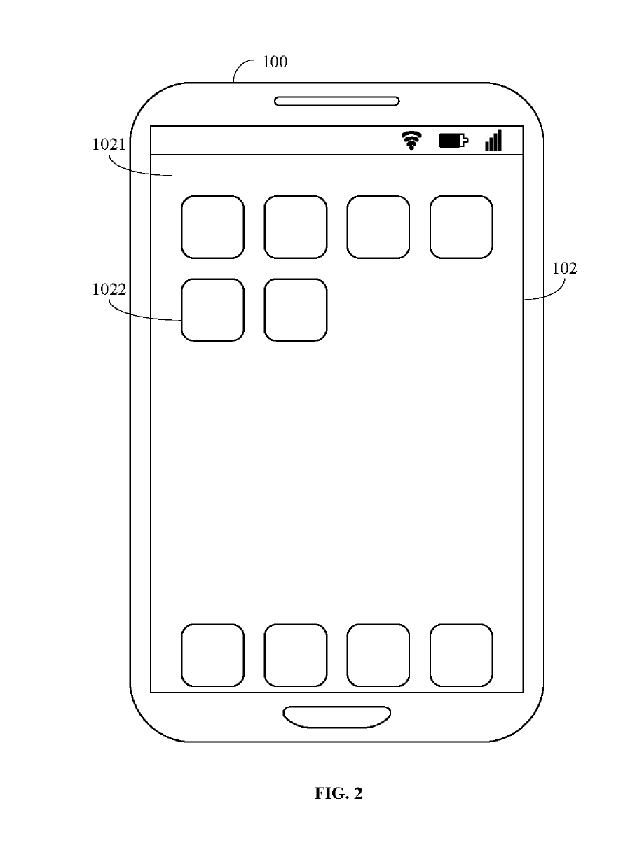

Referring to FIG. 2, the display device 102 displays a current page 1021. A number of icons 1022, associated with a number of applications, are displayed on the current page 1021.

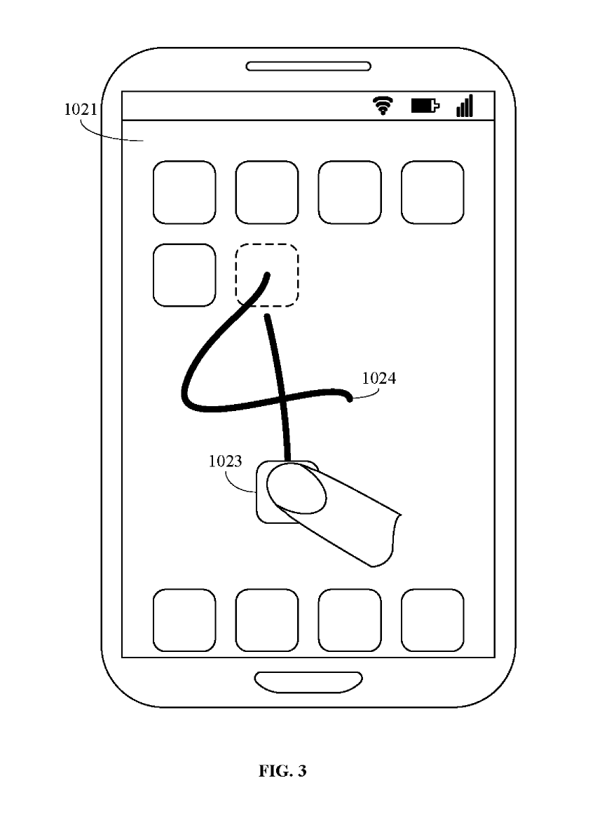

Referring to FIG. 3, the touch input device 101 detects a touch input on a selected icon 1023 of the icons 1022 by a user. The time detection module 201 detects a first time period of the duration of the touch input on the selected icon 1023 and determines whether the first time period is equal to or greater than a first preset time period. If the first time period on the selected icon 1023 is lower than the first preset time period, the first determination module 202 determines that the touch input on the selected icon 1023 is an icon click operation. In response to the icon click operation, the icon actuating module 203 actuates an application corresponding to the selected icon 1023. If the first time period on the selected icon 1023 is equal to or greater than the first preset time period, the first determination module 202 determines that the touch input on the selected icon 1023 is an icon move operation. In response to the icon move operation, the icon moving module 204 actuates the selected icon 1023 into a moveable state.

The touch input device 101 detects a drag operation on the selected icon 1023 on the current page 1021. The trace obtaining module 205 detects a trace 1024 of the drag operation. In at least one embodiment, the display device 102 displays the trace 1024, and the icon moving module 204 controls the display device 102 to update the location of the selected icon 1023 according to the trace 1024 of the drag operation.

After the drag operation ends, the second determination module 206 determines whether there is a new drag operation on the current page 1021 within a second preset time period. If there is a new drag operation on the current page 1021 within the second preset time period, the trace obtaining module 205 detects the trace of the new drag operation. If there is no new drag operation on the current page 1021 within the second preset time period, the second determination module 206 determines that the drag operation is finished.

If the drag operation is finished, the trace recognition module 207 recognizes the trace 1024 or a combination of traces 1024 and determines whether the trace 1024 or a combination of traces 1024 matches an image of a page number among a number of page numbers stored in the storage device 104. In at least one embodiment, the page numbers are selected from the group consisting of Arabic numerals, English letters and Chinese characters. The Arabic numerals can include “1, 2, 3, . . . ” The English letters can include “a, b, c, . . . ” The Chinese characters can include “—, [symbol] , [symbol] , . . . ” Each page number of the page numbers is associated with a page stored in the storage device 104.

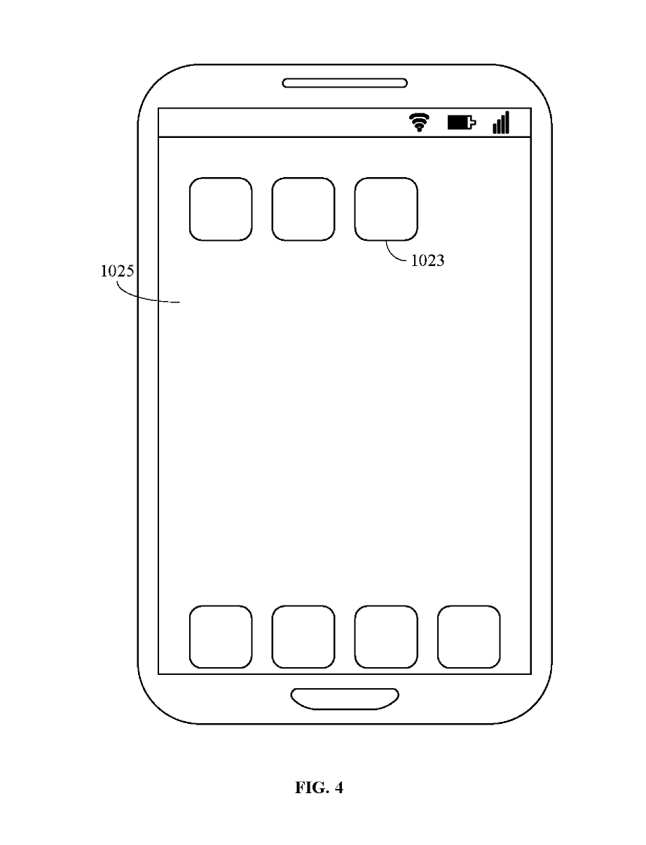

Referring to FIG. 4, if the trace 1024 or the combination of traces 1024 matches an image of a page number among the number of page numbers, the page flipping module 208 controls the display device 102 to display a page which is associated with a matching page number (target page 1025) and locates the selected icon 1023 on the target page 1025. If the trace 1024 or the combination of traces 1024 does not match an image of a page number among the number of page numbers, the current page 1021 will not be flipped over and the current page 1021 is maintained.

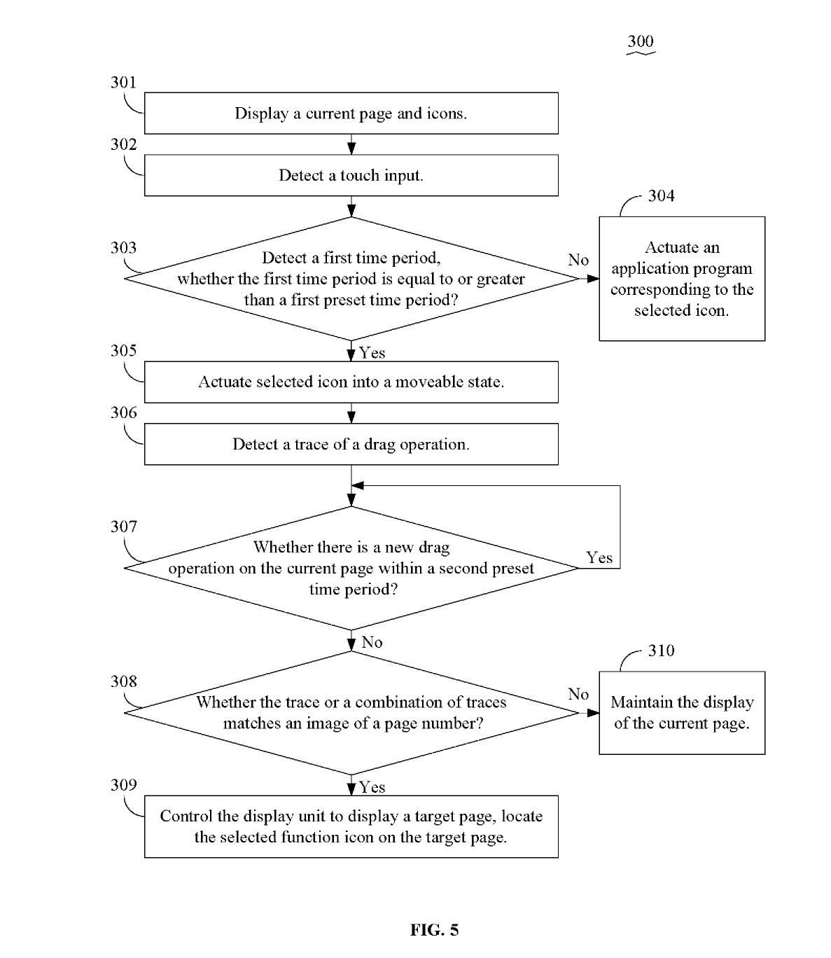

Referring to FIG. 5, a flowchart is presented in accordance with an example embodiment. A method 300 is provided by way of example, as there are a variety of ways to carry out the method. The method 300 described below can be carried out using the configurations illustrated in FIG. 1 and various elements of these figures are referenced in explaining example method 300. Each block shown in FIG. 5 represents one or more processes, methods, or routines, carried out in the exemplary method 300. Additionally, the illustrated order of blocks is by example only and the order of the blocks can be changed. The exemplary method 300 can begin at block 301.

At block 301, a current page is displayed and a number of icons, associated with a number of applications, are also displayed on the current page.

At block 302, a touch input device detects a touch input on a selected icon of the icons by a user.

At block 303, a time detection module detects a first time period of the duration of the touch input on the selected icon and a first determination module determines whether the first time period is equal to or greater than a first preset time period. If the first time period is equal to or greater than the first preset time period, the touch input on the selected icon is determined as an icon move operation and block 305 is implemented. If the first time period is lower than the first preset time period, the touch input on the selected icon is determined as an icon click operation and block 304 is implemented.

At block 304, an icon actuating module actuates an application corresponding to the selected icon.

At block 305, an icon moving module actuates the selected icon into a moveable state.

At block 306, the touch input device detects a trace of a drag operation on the selected icon on the current page. In at least one embodiment, the display device displays the trace, and the location of the selected icon can be updated according to the trace of the drag operation on the current page.

At block 307, a second determination module determines whether there is a new drag operation on the current page within a second preset time period, after the drag operation ends. If there is a new drag operation within the second preset time period, another trace of the new drag operation can be detected and block 307 is repeated. If there is no new drag operation within the second preset time period, the drag operation is determined to be finished and block 308 is implemented.

At block 308, a trace recognition module recognizes the trace or a combination of traces and determines whether the trace or the combination of traces matches an image of a page number among a number of page numbers stored in a storage device. If the trace or the combination of traces matches an image of a page number, block 309 is implemented. If the trace or the combination of traces does not match an image of any page number, block 310 is implemented. In at least one embodiment, the page numbers are selected from the group consisting of Arabic numerals, English letters and Chinese characters. Each page number of the page numbers is associated with a page stored in the storage device.

At block 309, a page flipping module controls the display device to display a page which is associated with a matching page number (target page), and locates the selected icon on the target page.

At block 310, the display device maintains the display of the current page.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

What is claimed is:

1. An icon management system comprising a plurality of modules stored in a non-transitory storage medium, which is executed by a processor, cause the processor to:
determine a touch input applied on an icon is an icon move operation;
actuate the icon into a moveable state;
detect a trace corresponding to a drag operation on the icon on a current page;
recognize the trace and determine whether the trace matches an image of a page number among a plurality of page numbers;
control a display device to display a target page which is associated with a matching page number, if the trace matches an image of a page number among the plurality of page numbers; and
locate the icon on the target page after the target page is displayed.

2. The icon management system of claim 1, further comprising a module stored in the non-transitory storage medium executed by the processor to: detect a first time period of the touch input on the icon and determine whether the first time period is equal to or greater than a first preset time period; determine the touch input on the icon as an icon move operation if the first time period on the icon is equal to or greater than the first preset time period; determine the touch input on the icon as an icon click operation if the first time period on the icon is lower than the first preset time period.

3. The icon management system of claim 2, further comprising a module stored in the non-transitory storage medium executed by the processor to: actuate an application corresponding to the icon, if the touch input on the icon is determined as an icon click operation.

4. The icon management system of claim 1, further comprising an module stored in the non-transitory storage medium executed by the processor to: determine whether there is new drag operation on the current page within a second preset time period after the drag operation ends; detect the trace of the new drag operation if there is a new drag operation on the current page within the second preset time period; recognize the trace/a combination of traces and determine whether the trace/combination of traces matches an image of a page number among the page numbers if there is no new drag operation on the current page within the second preset time period.

5. The icon management system of claim 1, wherein the page numbers are selected from the group consisting of Arabic numerals, English letters and Chinese characters.

6. The icon management system of claim 1, further comprising a module stored in the non-transitory storage medium executed by the processor to: maintain the display of the current page if the trace does not match an image of any page number among the page numbers.

7. An icon management method comprising:
executing a plurality of modules stored in a non-transitory storage medium by a processor for:
determining a touch input applied on a icon is an icon move operation;
actuating the icon into a moveable state;
detecting a trace corresponding to a drag operation on the icon on a current page;
recognizing the trace and determining whether the trace matches an image of a page number among a plurality of page numbers;
controlling a display device to display a target page which is associated with a matching page number, if the trace matches an image of a page number among the plurality of page numbers; and
locating the icon on the target page after the target page is displayed.

8. The icon management method of claim 7, wherein the method further comprising detecting a first time period of the touch input on the icon and determining whether the first time period is equal to or greater than a first preset time period; and determining the touch input on the icon as an icon move operation if the first time period on the icon is equal to or greater than the first preset time period; determining the touch input on the icon as an icon click operation if the first time period on the icon is lower than the first preset time period.

9. The icon management method of claim 8, wherein the method further comprising actuating an application corresponding to the icon, if the touch input on the icon is determined as an icon click operation.

10. The icon management method of claim 7, wherein the method further comprising determining whether there is a new drag operation on the current page within the second preset time period after the drag operation ends; detecting the trace of the new drag operation if there is a new drag operation on the current page within the second preset time period; recognizing the trace/a combination of traces and determining whether the trace/combination of traces matches an image of a page number among the page numbers if there is no new drag operation on the current page within the second preset time period.

11. The icon management method of claim 7, wherein the page numbers are selected from the group consisting of Arabic numerals, English letters and Chinese characters.

12. The icon management method of claim 7, wherein the method further comprising maintaining the display of the current page if the trace doesn't match an image of any page number among the page numbers.
